(19) United States
(12) Patent Application Publication
(10) Pub. No.: US 2015/0034176 A1
(43) Pub. Date: Feb. 5, 2015

(54) PIECE OF CONTINUOUS OPERATING CYCLE SLUDGE TRANSFER EQUIPMENT

(71) Applicant: EULEN S. A., Madrid (ES)

(72) Inventors: Jesus Angel GARCIA ARGÜELLES, Madrid (ES); Wenceslao DIAZ GARCIA, Madrid (ES)

(73) Assignee: EULEN S. A., Madrid (ES)

(21) Appl. No.: 14/065,961

(22) Filed: Oct. 29, 2013

(30) Foreign Application Priority Data
Aug. 2, 2013 (ES) P201331210

(51) Int. Cl. G05D 9/12

(52) U.S. Cl. CPC G05D 9/12
USPC 137/391

(57) ABSTRACT

Piece of continuous operating cycle sludge transfer equipment, which consists of two deposits (D1-D2), each one of which has a filling or suction circuit and another emptying or discharge circuit. A vacuum pump (Depr.) creates a depression in the first of the deposits, which causes the product to be sucked up from the outside, until said tank reaches a certain set level. Meanwhile, the other deposit is pressurized by means of a compressor (Compr.) coupled to a driving circuit, independent from the vacuum, in order for said deposit to be emptied and the sludge discharged towards an output channel at the adequate distance and height. When the first device is filled, the valves in the suction circuit of said deposit close automatically and those in the emptying circuit open, whilst the filling circuit in the other device opens and the emptying circuit closes.

### BACKGROUND OF THE INVENTION

1. Field of the Invention

The invention pertains to the field of sludge transfer equipment. More particularly, the invention pertains to a piece of continuous operating cycle sludge transfer equipment.

2. Description of Related Art

Transferring sludge within a certain area, for example in an industrial facility, from the place where it is produced to a pool or settling or treatment zone, by means of vehicles, presents significant limitations. Cistern vehicles with suction equipment are required, in order to load the sludge, which are very expensive. Furthermore, on certain occasions, this may constitute a dangerous task, given that corrosive loads may be being handled. Transportation by means of vehicle cannot be carried out continuously, unless a minimum of two units are available, which would make transportation costs even higher, owing to the number of operators and vehicles required for the operation.

Document ES 2 142 193 describes a piece of mobile suction-discharge equipment for sludge and/or effluents, which consists of two sludge and/or effluent recipients or receptor tanks, to be filled with the aid of a depressor, which acts as a vacuum pump, thereby facilitating suction, which in turn causes the sludge and/or effluents, to enter into one of the tanks until it is full, which is when the equipment's valves are either inverted completely or do not invert at all. Whilst the tank, full throughout this very same valve inversion, begins to be emptied, the other tank begins to fill up, up to a pre-determined, controlled level. The pump itself, which creates a vacuum absorbing the sludge in one deposit, serves to discharge the sludge in the other deposit, given that in theory, the gasses absorbed from the first are introduced into the second at pressure, which is why the performance of this equipment is very uncertain and in practice, almost impossible to achieve.

### SUMMARY OF THE INVENTION

The object of the present invention is a piece of sludge transfer equipment, for transferring sludge within a certain area, usually from the place where it is produced, to a pool or treatment deposit, being unique in that the sludge is sucked up and discharged in a continuous operating cycle.

The piece of equipment continuously transfers sludge and residual waters, including corrosive products, by means of sucking the same up and filling a deposit, whilst the sludge loaded in another deposit, situated in such a way that it is parallel to the first, is discharged towards the output.

The piece of equipment, object of the present invention, consists of two devices, each one of which has a filling or suction circuit and another emptying or discharge circuit. A vacuum pump creates a depression in the first of the deposits, which causes it to suck the product up from the outside, until said tank reaches a certain set level. Meanwhile, the other deposit is pressurized by means of a compressor, coupled to a discharge circuit, independent of that of the vacuum, in order for said deposit to empty and for the sludge to be discharged towards an output channel, at the adequate distance and height. When the first deposit fills the valves in the suction circuit of said device, they close automatically and those in the emptying circuit open, whilst the filling circuit of the other deposit is opened and the emptying circuit is closed.

The vacuum emptying and pressurization or, in other words, suction and discharge of the sludge, is carried out by means of an independent depressor (vacuum pump) and compressor, which notably improves the output and reliability of the assembly, in contrast to other pieces of equipment, which use the same system, i.e. a vacuum pump, to suck up and discharge at the same time. Upon separating the systems, the vacuum pump operates and performs optimally, producing a constant air flow and reaching its maximum vacuum level, the deposit thereby being filled more quickly. On the other hand, pressurizing the deposit in order to discharge the sludge by means of a compressor independently, makes it possible to perform the transfer at the height and distance desired, in less time and in a more reliable way, thus preventing blockages in the circulation tubes, caused by product accumulation.

Both the sludge input and output channels in the deposits are controlled by valves, just like the channels through which air is absorbed and discharged in the deposits. Therefore, whilst the first deposit is being emptied, the vacuum pump creates a depression in the second deposit, which causes it to fill up, up to a certain set level. Once it is full, the valves in the suction circuit of this deposit close and those in the discharge or emptying circuit open and close. Meanwhile, in the first deposit, the emptying valves are closed and the suction valves are opened, in order to once again fill said deposit.

All of these changes are made by means of the automatic valves operating, these valves being governed by an electronic control, which defines the sequence in which they should open and close automatically, based on the fill level or on a set time for filling. This sequence is repeated constantly, in such a way that whilst one of the deposits is filled the other empties. The improvement achieved by separating the two suction and discharge systems is reflected in the dramatic reduction in time spent during the filling and emptying cycles and the number of circulation tube blockage incidences. This results in a notable improvement in the equipment's performance and reliability.

The fact that the suction or intake is carried out by means of installing a vacuum pump of the vane or liquid ring variety, depending on the product to be transferred, as well as the fact that the product taken in is discharged by means of a compressor, which pressurises the deposit with the product to be discharged using independent devices, is notably advantageous for the following reasons:

The operation is more reliable, since discharge does not depend on the depressor blowing, as is the case with other systems.

Discharge services are improved, since they are not limited by the services of the depressor as a discharger.

The useful life of the depressor improves, since it operates naturally, without any backpressure other than atmospheric backpressure.

Suction capacity is greater, owing to the point mentioned directly above.

### BRIEF DESCRIPTION OF THE DRAWING

FIG. 1 is a schematic representation of the devices built into the piece of equipment, object of the present invention.

FIG. 2 represents an alternative embodiment of the piece of equipment, object of the present invention, likewise being a schematic representation of the devices built into it.

### DETAILED DESCRIPTION OF THE INVENTION

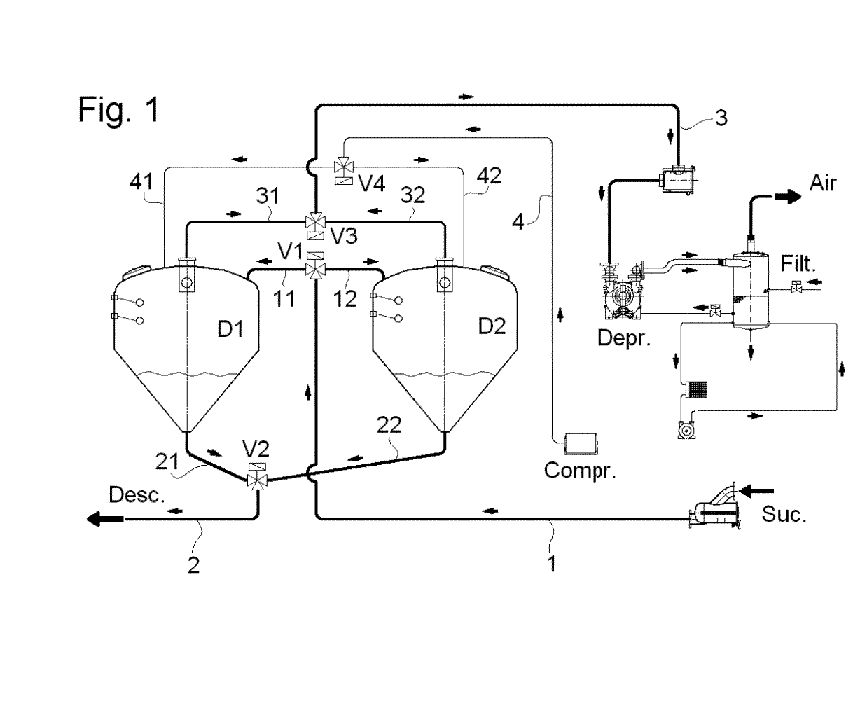

As can be seen in FIG. 1, the piece of continuous operating cycle sludge transfer equipment includes two sealed deposits (D1-D2) with a conical base, suitable for enduring pressure or for a vacuum to be created therein, which are alternately filled and emptied via both sludge input (11-12) and output (21-22) channels.

The general sludge input channel (1) comes from the respective deposits (D1-D2) in both branches (11-12). The input of sludge into the desired branch is controlled by an electro-pneumatic valve (V1), which closes and opens said inputs (11-12) in opposite directions, via the electrical level signal, indicative of either fill or vacuum level, in the corresponding deposit. Therefore, when the deposit being filled reaches a certain set level or has been being filled for a certain set length of time, the input channel to the same closes, whilst the channel of the other deposit opens.

The general sludge output channel (2) is connected to both offshoots (21-22) coming from the respective deposits (D1-D2), which are controlled by a valve (V2), which closes and opens the outputs (21-22) in opposite directions, depending on the deposit being filled or emptied.

The air absorption channel (3) has a built in depressor (Depr.), at the output of which a water filter (Filtr.) is coupled, which purifies the air before it is released into the environment (Air). This channel comes from both branches (31-32), which are coupled to both deposits (D1-D2); it is controlled by means of a valve (V3), through which the absorption which contributes to filling the corresponding deposit takes place, bearing in mind that the respective absorption channels (31-32) open and close in opposite directions from one another, depending on the deposit to be filled or emptied.

The discharge channel (4) for pressurised air coming from a compressor (Compr.) comes from both branches (41-42), which are coupled to both deposits (D1-D2). The valve (V4) closes or opens the discharge channel (41-42) depending on the deposit to be filled or emptied, whilst it enables this opening and closing operation to be carried out in opposite directions.

The vacuum pump (Depr.) is connected to both deposits (D1-D2) through a channel (3), with an air filter (Filtr.) built into the output for the air absorbed from the respective deposit. This pump is of the vane or liquid ring variety, depending on the product to be transferred.

Meanwhile, the compressor (Compr.) is connected to both deposits through a channel (4). In order to discharge the product of the deposit to be emptied, the same is pressurised using the compressor, before the corresponding output valve is opened. As explained above, the suction and discharge manoeuvres through the two deposits (D1-D2), (one loading and the other unloading) are carried out by means of electro-pneumatic valves, which are driven by the electrical fill or vacuum level signal.

This piece of equipment is controlled by means of an electronic control device, into which both level sensors are built as a detection means for gauging the load situation of the deposits, based on which control signals are generated, in order to control the operation of all the valves charged with emptying one of the deposits, by opening its sludge discharge and output channels, whilst the input and absorption channels close. Meanwhile, the other deposit is filled, the respective channels of the same therefore being situated in such a way that they are opposite to the previous deposit, in order for this deposit to be successfully filled.

In the example described to this point herein, represented in FIG. 1, the valves which control the two sludge input and output channels and absorption and suction channels for gasses in the deposits (D1-D2) are three way valves, which operate in the opposite direction in the routes which control the channel connected to a deposit, in relation to that which is connected to the other deposit.

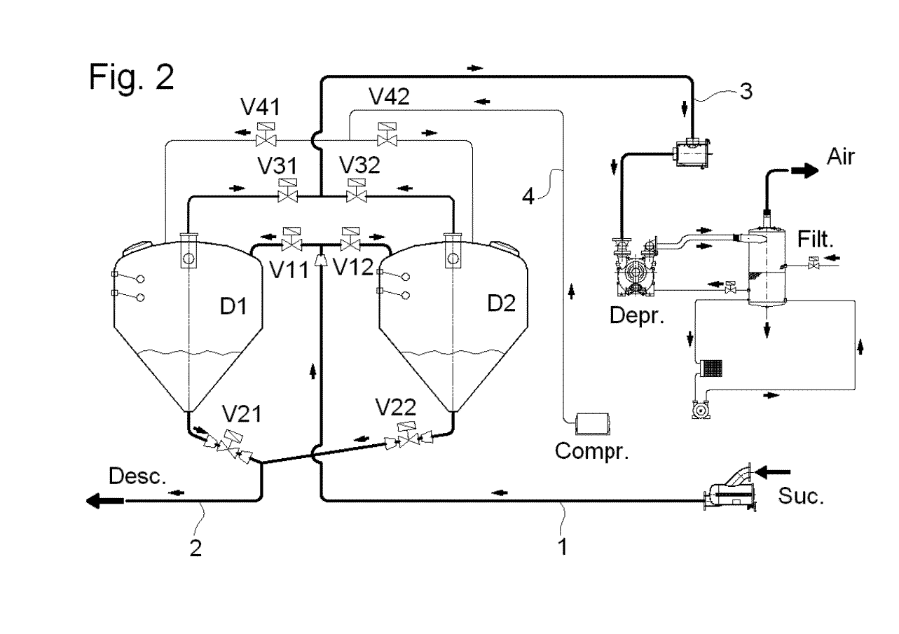

The example in FIG. 2 concerns double acting valves and therefore in each one of the input, output, absorption and suction channels, leading from each device (D1-D2), is controlled by a double acting valve, which opens or closes the channel upon which it is installed, those located in the channel being equivalent to both deposits programmed in opposite directions, so that one is open, whilst the other is closed and vice versa. Therefore, when the valves (V21) and (V41), which indicate that the deposit (D1) is being emptied, are opened, the valves (V11) and (V13) remain closed. Likewise, in the deposit (D2) the valves (V22) and (V42) would be closed and the valves (V12) and (V31) would be opened, these valves providing the load to this deposit.

The piece of equipment has an electrical manoeuvre and security switchboard, as well as another electro-pneumatic switchboard, composed of electrovalves and air piping to the manoeuvre valves.

After having described the nature of the invention sufficiently, as well as a preferred embodiment thereof, it must be timely noted that the materials, form, size and arrangement of the elements described herein may be amended, providing that amendments do not alter the essential characteristics of the invention claimed below:

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. Piece of continuous operating cycle sludge transfer equipment, comprising:
two sealed deposits (D1-D2), with a conical base, which are suitable for enduring pressure or for a vacuum being created therein, which are filled and emptied alternately, via both sludge input and output channels;
a sludge input channel (1), which comes from the respective deposits (D1-D2) in both branches (11-12), which are controlled by at least one electro-pneumatic valve (V1), which closes and opens said inputs (11-12) in opposite directions, by means of the electronic level signal, whether indicating fill level or vacuum level, in the corresponding deposit;
a sludge output channel (2), connected to both offshoots (21-22) coming from the respective deposits (D1-D2), which are controlled by at least one valve (V2), which closes and opens the outputs (21-22) in opposite directions, depending on the deposit being filled or emptied;
an air absorption channel (3), with a built in depressor (Depr.), which comes from both branches (31-32), coupled to both deposits (D1-D2), which are controlled by at least one valve (V3), which operate in opposite directions, closing or opening the absorption channels (31-32), depending on the device to be emptied or filled;
a pressurised air discharge channel (4) for pressurised air coming from a compressor (Compr.), which comes from both branches (41-42), coupled to both deposits (D1-D2), which are controlled by at least one valve (V4), which operate in opposite directions, closing and opening the discharge channel (41-42), depending on the deposit to be filled or emptied;
a depressor (Depr.) connected through a channel (3) to both deposits (D1-D2), with a built in filter air (Filtr.) in the output for the air absorbed from the respective deposit;
a compressor (Compr.) connected through a channel (4) to both deposits.
an electronic control device for the piece of equipment, which has both level sensors built in as detection means for detecting the load situation of the deposits, depending on which control signals are generated for controlling the operation of all the valves charged with emptying one of the deposits, opening its sludge discharge channels and output, whilst closing the input and absorption channels. Meanwhile, the other deposit is filled, the respective channels of the same therefore being located in a position opposite to that of the other deposit, in order to successfully fill the same.

2. Piece of equipment, according to claim 1, characterised in that the valves which control the sludge input and output channels and absorption and suction channels for gasses in the deposits (D1-D2) are three way valves which operate in opposite directions, in those routes which control the channel connected to a deposit, in relation to the one connected to the other deposit.

3. Piece of equipment according to claim 1, characterised in that each and every one of the input, output, absorption and suction channels, which come from each deposit (D1-D2) is controlled by a double acting valve, which opens or closes the channel upon which it is installed, those valves being located in the channel being equivalent in both deposits, programmed in opposite directions, in order for one to be open, whilst the other is closed and vice versa.

4. Piece of equipment according to claim 1, characterised in that the suction or intake is carried out by means of installing a vacuum pump of the vane or liquid ring variety, depending on the product to be transferred.

5. Piece of equipment according to claim 1, characterized in that the deposit product is discharged by means of a compressor, which pressurizes the deposit to be emptied.
